(19) United States
(12) Patent Application Publication
(10) Pub. No.: US 2025/0060488 A1
(43) Pub. Date: Feb. 20, 2025

(54) DEVICE AND SYSTEM FOR MONITORING GEOLOGICAL AND STRUCTURAL DISPLACEMENT

(71) Applicant: Mthing Pty Ltd, Milton (AU)

(72) Inventors: Lee Anthony HELLEN, Milton (AU); Jun WANG, Milton (AU); Shane FRISCHKORN, Milton (AU); David CHOY, Seventeen Mile Rocks (AU); John CLAIR, Seventeen Mile Rocks (AU); Priyanka MONGA, Seventeen Mile Rocks (AU); Joshua DONALDSON, Seventeen Mile Rocks (AU); Miguel FUENTES, Seventeen Mile Rocks (AU); Jeremy COURCIERES, Seventeen Mile Rocks (AU); Charles WANG, Brisbane (AU); Yanming FENG, Brisbane (AU)

(73) Assignee: Mthing Pty Ltd, Milton, QL (AU)

(21) Appl. No.: 18/723,539

(22) PCT Filed: Dec. 22, 2022
(86) PCT No.: PCT/AU2022/051566

§ 371 Date: Jun. 24, 2024

(30) Foreign Application Priority Data
Dec. 23, 2021 (AU) 2021904246

(51) Int. Cl. G01S 19/26; G01S 19/34; G01S 19/37

(52) U.S. Cl. CPC G01S 19/26; G01S 19/34; G01S 19/37

(57) ABSTRACT

Some embodiments relate to a position monitoring device. The position monitoring device may comprise memory accessible to the processor; and a sealed housing containing a processor, a geo-spatial positioning module, a geo-spatial positioning antenna, a solar cell module, a power supply module, and a first communications module. The geo-spatial positioning module coupled to the geo-spatial positioning antenna and configured to generate geo-spatial positioning data based on an output of the geo-spatial positioning antenna that specifies a geo-spatial position of the position monitoring device. The memory may contain instructions which, when executed by the processor, cause the processor to: transmit geo-spatial positioning information from the first communications module to a device external to the position monitoring device.

### CROSS-REFERENCE TO RELATED APPLICATIONS

This application is a national phase application of International Application No. PCT/AU2022/051566, filed Dec. 22, 2022, which claims priority to Australia Patent Application Serial No. 2021904246, filed Dec. 23, 2021.

### BACKGROUND

Embodiments described herein relate generally to devices positioned in surveying environments which monitor geological or structural displacement over time.

Surveying devices positioned in surveying environments may not have access to electricity grid power supply yet may be required to have long operational longevity requirements. However, such devices may be unprotected to environmental conditions, such as weather and attracting fauna for example birds, which may damage the devices. Such devices may also have low bandwidth and/or long range communication requirements to send/receive measurement and/or communications data to/from a receiving server.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a position monitoring device, comprising: a processor; memory accessible to the processor; a geo-spatial positioning antenna; a geo-spatial positioning module coupled to the geo-spatial positioning antenna and configured to generate geo-spatial positioning data based on an output of the geo-spatial positioning antenna that specifies a geo-spatial position of the position monitoring device; a power supply module; a solar cell module to charge the power supply module; a first communications module; and a sealed housing containing the processor, the geo-spatial positioning module, the geo-spatial positioning antenna, the solar cell module, the power supply module, and the first communications module. The memory contains instructions which, when executed by the processor, cause the processor to: transmit geo-spatial positioning information from the first communications module to a device external to the position monitoring device.

The sealed housing may include at least one light transmissive wall to allow light into the sealed housing in an area within the sealed housing where the solar cell module is mounted.

The solar cell module may be located near the at least one light transmissive wall so that there is a direct path for light to enter through the sealed housing to the solar cell module.

Portions of the sealed housing other than the at least one light transmissive wall may be opaque or translucent.

The position monitoring device may include an operational orientation having an upright posture, wherein the sealed housing comprises a peaked top portion, the peaked top portion being the uppermost portion of the sealed housing when the position monitoring device is in the operational orientation.

The peaked top portion may define a narrowing chamber that receives the geo-spatial positioning antenna.

In some embodiments, the sealed housing comprises a base portion, the base portion being a lowermost portion of the sealed housing when the position monitoring device is in the operational orientation.

The at least one light transmissive wall may extend between the base portion and peaked top portion, the at least one light transmissive wall may be angled from its highest point between about 90 and 175 degrees from a vertical axis when in the operational orientation.

The sealed housing may comprise an upper portion. The upper portion and/or the base portion may be formed by injection-molded plastics. In some embodiments, the upper portion includes the peaked top portion and the at least one light transmissive wall. In some embodiments, the upper portion comprises polyurethane axson plastic, and the at least one light transmissive wall comprises a polished external (i.e. surface) finish.

The base portion may comprise a mounting connector to allow the position monitoring device to be mounted upon equipment and/or a structure.

The position monitoring device may comprise an antenna platform. The geo-spatial positioning antenna may be mounted upright on the antenna platform, the geo-spatial positioning antenna may be aligned on a vertical axis when the device is in the operational orientation, and the vertical axis may pass through the mounting connector.

In some embodiments, the power supply module is housed on a base assembly, the base assembly including the base portion.

In some embodiments, the solar cell module is mounted on a solar mounting portion, the solar mounting portion located near the at least one light transmissive wall so that there is a direct path for light to enter through the sealed housing to the solar cell module.

In some embodiments, the solar cell module and solar mounting portion are oriented parallel to the at least one light transmissive wall, so that they are also angled from their highest point between about 90 and 175 degrees from a vertical axis when the device is in the operational orientation.

In some embodiments, the solar cell module and/or solar mounting portion are oriented and are of relative size so as to obstruct light permeating through the at least one light transmissive wall to other components within the sealed housing.

The solar mounting portion may contain an extension connection to the antenna platform.

The position monitoring device may further comprise a printed circuit board, PCB, located in the sealed housing. The PCB may be mounted vertically when the device is in the operational orientation. In some embodiments, the PCB has the antenna platform mounted to a top part of the PCB.

In some embodiments, the first communications module is configured for a first low power wireless communications standard and the position monitoring device further comprises a first communications antenna communicatively coupled to the first communications module.

In some embodiments, the first communications antenna is fitted to extend from the base portion.

The position monitoring device may further comprise a distance sensor, to measure a distance between the device and a ground or floor surface below the distance sensor when the device is mounted.

In some embodiments, the base portion comprises a sheathing recess so that the distance sensor may be housed within the sheathing recess. In some embodiments, the distance sensor is an ultrasonic sensor.

The position monitoring device may further comprise an inertial measurement unit, IMU, wherein upon a vibration of a threshold magnitude, the IMU is configured to send a signal to the processor to activate the processor.

In some embodiments, the sealed housing is made from an injection molded plastic and provides at least an IP65 or IP67 rating.

The position monitoring device may further comprise one or more atmospheric sensors, wherein the one or more atmospheric sensors are contained within the lowest heat gain position on the printed circuit board.

The position monitoring device may further comprise a second communications module configured for a second low power wireless communications standard. The position monitoring device may further comprise a second communications antenna communicatively coupled to the second communications module. The second communications antenna may be fitted to extend from the base portion.

Some embodiments relate to a system for monitoring settlement comprising one or more position monitoring devices described herein, a gateway for forwarding collected data from the one or more position monitoring devices, and a server system for processing the forwarded data.

In some embodiments, the server system is configured to communicate configuration data to at least one of the one or more position monitoring devices, the at least one of the one or more position monitoring devices being able to use the configuration data to configure at least one of its processor, memory accessible to the processor, the geo-spatial positioning module, and the first communications module.

### BRIEF DESCRIPTION OF DRAWINGS

FIG. 1 is a block diagram of a sensor system 100 according to some embodiments.

FIG. 2 shows internal and external components of device 110 from side view according to some embodiments.

FIG. 3 shows an upper portion 215 of a sealed housing 210 of the device 110 according to some embodiments.

FIG. 4 shows internal and external components of device 110 from a front view according to some embodiments.

FIG. 5 shows internal and external components of device 110 from side view according to some other embodiments.

FIG. 6 shows an underside view of device 110 according to some embodiments.

FIG. 7 shows an exploded view of device 110 according to some embodiments.

FIG. 8 shows an exploded view of components of base portion 240 according to some embodiments.

FIG. 9 shows an exploded view of components of device 110 according to some embodiments.

FIG. 10 shows antenna parts of device 110 according to some embodiments.

FIG. 11 shows a schematic of electronic and power components of device 110 according to some embodiments.

FIG. 12 shows a software architecture diagram of device 110 according to some embodiments.

FIG. 13 shows a memory allocation of processor 1160 and memory 1163 according to some embodiments.

FIG. 14 shows a perspective view of the underside of device 110 according to some other embodiments.

FIG. 15 shows a perspective view of device 110 according to some other embodiments.

### DETAILED DESCRIPTION

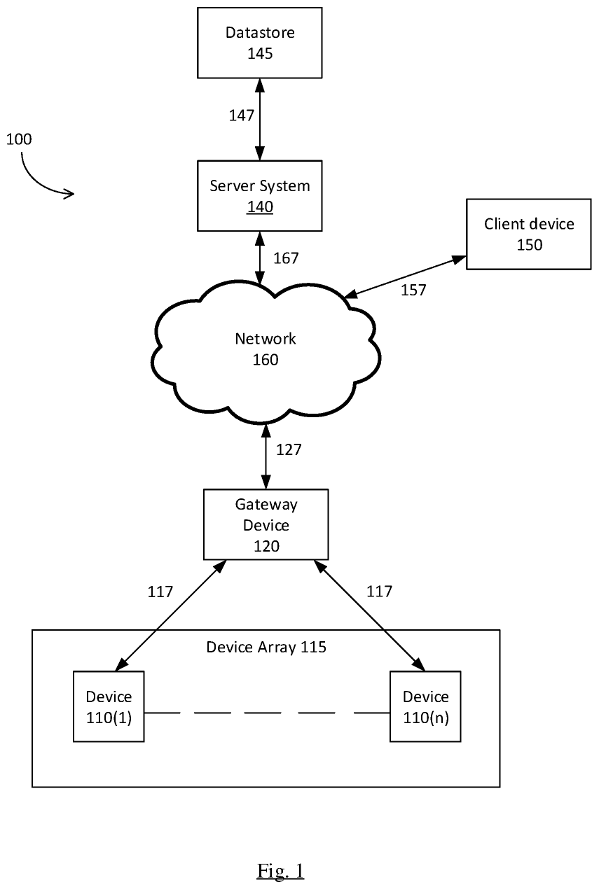

FIG. 1 is a block diagram of a sensor system 100 according to some embodiments. The sensor system 100 comprises a device array 115. The device array 115 comprises one or more devices 110. The devices 110 may also be referred to as a surveying device 110, surveying unit 110, monitoring device 110, monitoring unit 110, a position monitoring unit 110, a position monitoring device 110, a geo-position determining unit 110, a geo-positioning determining device 110, a node 110, an end-node 110, or a node device 110, for example. In the context of the present description, each device 110 may be remotely located in a difficult to access position or area for conventional network connections. In some embodiments, devices 110 are located in a project area. The project area may be a land area over which measurements of settlement are desired, for example. The device 110 is positioned at a distance from a gateway device 120 such that wireless communication between the device 110 and the gateway device 120 is feasible. In some embodiments, the farthest position of the device 110 from the gateway device 120 may be a distance of 1, 2, or 5 km, for example.

Each device 110 may collect and transmit a Global Navigation Satellite System (GNSS) data stream for each independent observation epoch or file for each observation session over a predefined period of time. In some embodiments, the device 110 operates on a duty cycle basis or an on-demand basis for collection of the GNSS data. The GNSS data collection may be referred to as readings, loggings, or measurements. The device 110 may collect the GNSS data for a period of 4 hours, 5 hours, 6 hours, 7 hours, 8 hours, 10 hours or 12 hours every 24 hours, for example. In some other embodiments, the device 110 may perform readings at a different frequency, such as twice a week, for example. In some embodiments, the device 110 may collect the GNSS data for a predefined and configurable number of hours every 24 hours. In some embodiments, the device 110 may collect the GNSS data for multiple predefined periods within a larger period (e.g. 24 hours). For example, the device 110 may collect the GNSS data for two periods in a day, with each period lasting 3, 4 or 5 hours. The GNSS data stream may assist device 110 in measuring geological and/or structural displacement, including geological settlement, for example.

Communication link 117 comprises wireless communication links between devices 110 and the gateway device 120. The wireless communication link 117 may be a communication link in the form of a LoRa™ wireless link or a Narrowband Internet of Things (NB-IoT) wireless link or Sigfox™ low power wide area network (LPWAN) wireless link or any other wireless communication link suitable for LPWAN communication. In some other embodiments, gateway device 120 and/or device 110 may be configured to perform Wi-Fi HaLow™ communications on communications link 117 for improved data transfer rates.

Communications over the LPWAN may involve lower data transfer rates or bandwidth in comparison to conventional mobile phone networks, for example data communication rates of less than 1 megabytes per second. In some embodiments, the data transfer rate of an LPWAN could be in the range of 0.1 to 50 kilobytes per second per radio communication channel. The radio frequency power emitted by the devices 110 that communicate over the LPWAN may be in the range of 10 to 25milliwatts or 10 to 500 milliwatts or 10 milliwatts to 1 watt, for example. The low data rates and low radio frequency power allow for a reduced overall power consumption or demand, allowing a device 110 and/or gateway device 120 to operate on low power for prolonged periods. Device 110 may be powered with batteries in combination with a local energy subsystem, such as solar cells. LPWAN communication may occur over publically available radiofrequency spectrum bands.

In some embodiments, the gateway device 120 may facilitate or act as a part of an “internet of things” (IoT) network. In the internet of things network, the devices 110 may be viewed as representative of “things” that form part of the network.

The gateway device 120 is connected to the device 110 over a low power wide area network (LPWAN). The low power wide area network is a wireless communication network. The LPWAN may comprise a network of devices 110 that is spread across a radius of around 5 km (relative to the gateway device 120), for example. In some embodiments, a cluster of devices 110 may be deployed at a surveying site within a 5 km radius of the gateway device. In some embodiments, when devices 110 are utilising WiFi HaLow in concurrent station and access point (STA-AP) mode, devices 110 can be deployed with a 1 km radius in a star network. In some embodiments, when devices 110 are utilising WiFi HaLow in concurrent station and access point (STA-AP) mode, devices 110 can be deployed with a 2 to 3 km radius in a mesh network. In some embodiments, multiple gateway devices 120 may be deployed adjacently (i.e. separated by a distance that is less than the communication limit) to further extend the network. Adjacent gateway devices 120 may be separated from each other by a distance within 5 km, for example.

In some embodiments, the gateway device 120 is another one of the devices 110 which has communication abilities to communicate with a server 140. The device array 115 may comprise the gateway device 120. The gateway device 120 may be referred to as a reference point 120 or reference device 120, and perform differential calculations as the reference station for the device array 115. The devices 110 of device array 115 and gateway device 120 are performing measurements and calculations as part of a differential GNSS system. The gateway device 120 communication capabilities with server 140 may comprise mobile data communications, such as LTE-M or LTE Cat-M1, for example. In some embodiments, all or some of devices 110 may be capable of mobile data communications with server 140, such as by LTE Cat-M1 for example.

In some other embodiments, the gateway device 120 may be a fog computing station. The devices 110 transmit the data to a gateway device 120. The gateway device 120 may be a platform for integrated computation, storage and network services that are distributed and virtualised.

The gateway device 120 is typically located at the network edge, close to, or part of the project area. Gateway device 120 communicates with each device 110 to control the operation of the device 110. The system 100 may comprise a single gateway device 120 which each device 110 communicates with or, alternatively, a plurality of gateway devices 120 adapted to interface with a subset of the devices 110 of device array 115.

The sensor system 100 also comprises a network 160, server system 140, datastore 145, and client device 150. Network 160 is capable of communicating with gateway device 120 over a communication link 127. Network 160 is capable of communicating with server system 140 over communications link 167. Gateway device 120 is capable of communicating with server system 140 via network 160, and communication links 127 and 167. One or more devices 110 may be capable of communicating with server system 140 via gateway device 120, network 160, and communication links 117, 127, and 167. In some embodiments one or more device 110 may be capable of communicating with server system 140 directly via network 160 and communication link 167, such as when communicating via a mobile network such as LTE Cat M1. Network 160 may be a conventional internet connection, enterprise network, and/or dedicated communication/transmission services over satellite and/or optical links.

The gateway device 120 may typically transmit to a server system 140 which receives the data which may have been collected and computed by the gateway 120 from each of the devices 110. Therefore, gateway 120 may forward collected data from one or more devices 110.

The data transmissions may include transmission of half-hourly data files to server system 140 for the project area, for example.

In some embodiments, server system 140 may be communicatively coupled to datastore 145. Server system 140 is configured to store and/or retrieve the data from data store 145, such as data communicated by the devices 110 and/or collected data forwarded by gateway 120.

The client device 150 may be communicatively coupled to server system 140 via network 160. Client device 150 may be communicatively coupled to network 160 via communication link 157. The client device 150 may be able to retrieve the data from server system 140.

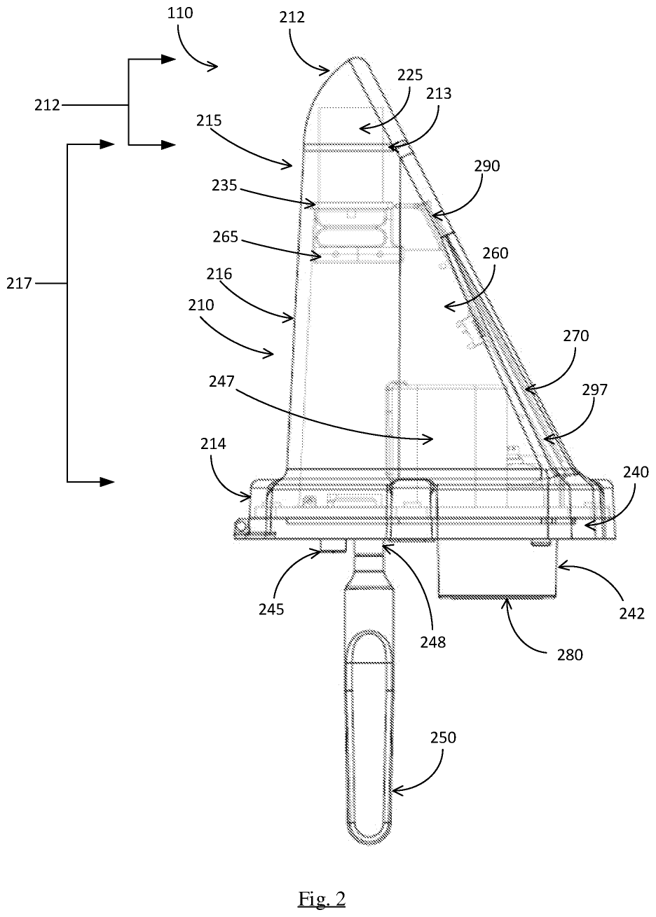

Referring now to FIGS. 2 to 9, structures and components of the device 110 are described in further detail according to some embodiments.

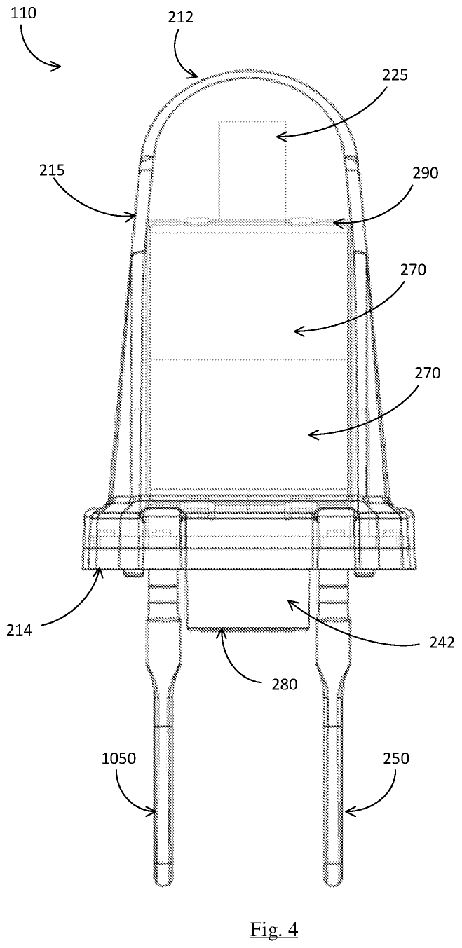

FIGS. 2 and 4 show the device 110 according to some embodiments, from side and front views respectively. As shown in FIG. 2, device 110 may comprise a sealed housing 210, a printed circuit board 260, a geo-spatial positioning antenna 225, an antenna platform 235, a solar cell support structure 290, a solar cell module 270, a distance sensor 280, a second communications antenna 1050, and a first communications antenna 250. Furthermore, the sealed housing 210 may comprise an upper portion 215 and a base portion 240. The upper portion 215 and the base portion 240 cooperate to form the sealed housing 210 when mated and sealed with each other.

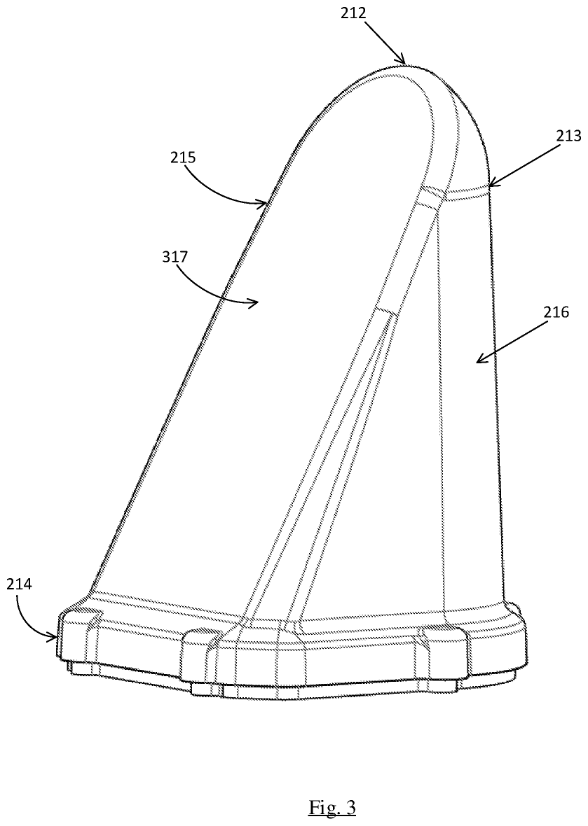

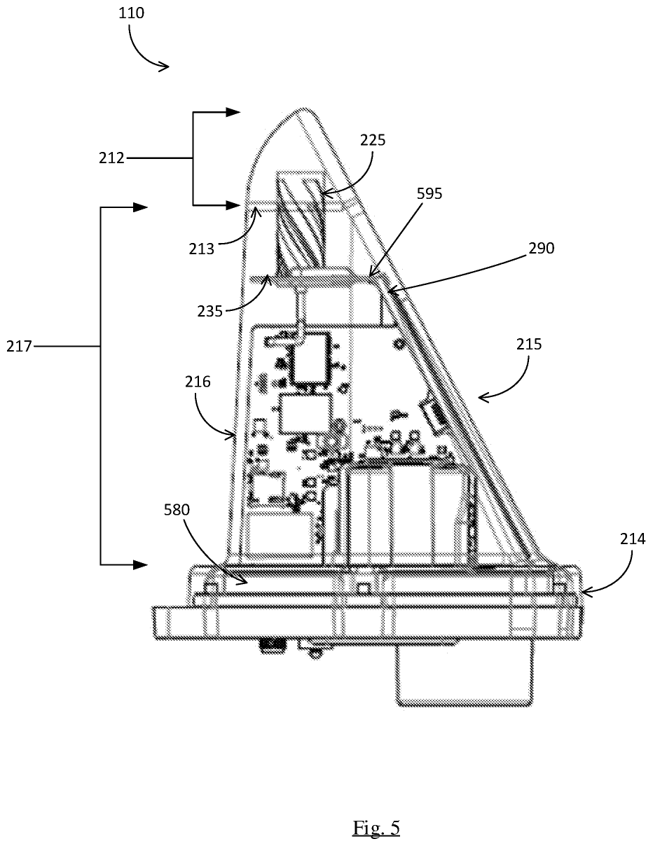

As shown in FIGS. 2, 3, 4, and 5, the upper portion 215 may be a hollow structure which generally tapers inwards from an open base to a peaked top portion 212. Therefore, upper portion 215 may include the peaked top portion 212. The open base may be a base receiving portion 214 which is designed to attach the base portion 240 to the upper portion 215, to seal the sealed housing 210. There may be an upper portion demarcation 213 which may show a demarcation of the peaked top portion 212 to the remainder of the upper portion 215, as shown in FIGS. 3 and 5.

The upper portion 215 may comprise a front flat face 317 as shown in FIG. 3. The front flat face may taper towards the peaked top portion 212 at a constant angle, as shown in FIGS. 2 and 5. In some embodiments, part of the front flat face may cross the upper portion demarcation 213 and form part of the peaked top portion 212.

The upper portion 215 may comprise a curved back side 216, as shown in FIGS. 2, 3 and 5. The curved back side may taper towards the peaked top portion 212 at a more vertical and/or gradual angle from the base than the tapering of the front flat face, with the curved back side sharply tapering at the peaked top portion 212 towards an apex of the peaked top portion 212, as shown in FIGS. 2, 3 and 5. The upper portion 215 may comprise polygonal faces.

The upper portion 215 may be also referred to as a dome, upper body, and/or dome lens, for example. The upper portion 215 and base portion 240 may be fixed together to seal the sealed housing 210. The upper portion 215 may include a peaked top portion 212, a central portion 217, and a base receiving portion 214, as shown in FIGS. 2 and 5. The upper portion 215 may be hollow to receive components of the device 110, and sealed by attaching the base portion 240 to the base receiving portion 214 of the upper portion 215. The central portion 217 may house most of the components within the sealed housing 210.

As shown in FIG. 3, the front flat face 317 comprises a light transmissive wall, and herein may be referred to as the light transmissive wall 317. The light transmissive wall 317 may be a window. The upper portion 215 of the sealed housing 210 includes the light transmissive wall 317. The light transmissive wall 317 may be or include the front flat face of the upper portion 215. The light transmissive wall 317 may allow light into the sealed housing 210 in an area within the sealed housing 210 where the solar cell module 270 is mounted. The light transmissive wall 317 may have as little attenuation of light as possible and/or be transparent. In some embodiments, the light transmissive wall 317 may be somewhat translucent. In some other embodiments sealed housing 210 may include two or more light transmissive walls 317.

The solar cell module 270 may be located near the light transmissive wall 317 so that there is a direct path for light to enter through the sealed housing 210 to the solar cell module 270. Solar cell module 270 may comprise one or more solar cells and/or solar modules. Solar cell module 270 may comprise one, two, three, four, and/or any greater integer number of solar cells and/or modules practical to be placed within sealed housing 210.

As shown in FIGS. 2, 7 and 9, the device 110 may also comprise an antenna platform 235 for mounting the geo-spatial positioning antenna 225. The printed circuit board 260 may comprise a PCB extension connection 265 to the antenna platform 235, as shown in FIG. 2. According to some embodiments, as shown in FIG. 5 the solar cell support structure 290 may comprise a solar extension connection 595 to the antenna platform 235. The printed circuit board 260, PCB extension connection 265, solar cell support structure 290, and/or solar extension connection 595 may provide a rigidity of the geo-spatial positioning antenna 225 within the device 110, to help maintain a fixed position for the phase centre of the geo-spatial positioning antenna 225. According to some embodiments, the printed circuit board 260 may also be attached to the solar cell support structure 290.

The solar cell support structure 290 may comprise a solar cell mounting portion 297 for mounting the solar cell module 270. Therefore, solar cell module 270 may be mounted on solar cell mounting portion 297. The solar cell mounting portion 297 may be located near the light transmissive wall 317 so that there is a direct path for light to enter through wall 317 of the sealed housing 210 to the solar cell module 270. The solar cell module 270 is positioned to lie between the light-transmissive wall 317 of upper housing portion 215 and the solar cell mounting portion 297. In this position, the solar cell module 270 may be generally parallel with the light-transmissive wall 317 and the solar cell mounting portion 297.

The base portion 240 may comprise a distance sensor receiving portion 242, an antenna receiving portion 248, a power supply module 247, and a mounting connector 245. The mounting connector 245 may be a connector which allows the device 110 to be mounted upon equipment and/or a structure. The equipment may comprise a survey pole and/or survey prism for example.

According to some embodiments, at least one of the printed circuit board 260, the geo-spatial positioning antenna 225, the solar cell module 270, the power supply module 247, and/or distance sensor 280 is contained within the sealed housing 210.

In some embodiments, the device 110 includes an operational orientation. The operational orientation may include the device 110 having an upright posture. In the operational orientation, the peaked top portion 212 may be the uppermost portion of the upper portion 215 and/or sealed housing 210 of the device 110 in relation to the surface of the earth. In the operational orientation the base portion 240 may be the lowermost portion of the sealed housing 210 in relation to the surface of the earth.

As shown from the side profile in FIG. 2, the upper portion 215 may be shaped so that there is an upright “spine”, the peaked top portion 212, and the light transmissive wall 317, which may be straight and slanted. The light transmissive wall 317 may extend between the top portion 212 and the base receiving portion 214. The solar cell module 270 and the solar cell mounting portion 297 may be orientated generally parallel to the light transmissive wall 317. In some embodiments, the light transmissive wall 317, the solar cell mounting portion 297, and/or the solar cell module 270 may be slanted so as to maximize solar charging time and/or efficiency while also providing enough slope to avoid the light transmissive wall 317 and/or device 110 accumulating rainfall. In some embodiments, the light transmissive wall 317, the solar cell mounting portion 297, and/or the solar cell module 270 may be angled/slanted from their respective highest points between about 90 and 175 degrees from a vertical axis when in the operational orientation. The light transmissive wall 317, the solar cell mounting portion 297, and/or the solar cell module 270 may be angled/slanted from their respective highest point between about 170 and 175 degrees, 160 and 170 degrees, 140 and 165 degrees from a vertical axis when in the operational orientation, for example. The light transmissive wall 317, the solar cell mounting portion 297, and/or the solar cell module 270 may be angled/slanted from their highest points of about 140, 141, 142, 143, 144, 145, 146, 147, 148, 149, 150, 151, 152, 153, 154, 155, 156, 157, 158, 159, 160, 161, 162, 163, 164, and/or 165 degrees from a vertical axis when in the operational orientation, for example. The light transmissive wall 317 may be slanted to form an acute angle between the light transmissive wall 317 and the base receiving portion 214.

In some embodiments, the peaked top portion 212 is peaked rather than flat to allow run-off to reduce the accumulation of rain/matter, and to prevent fauna such as birds from resting and/or nesting upon the device 110.

As shown in FIGS. 2, 5, 7, and 9, the printed circuit board 260 may be oriented vertically when in operational orientation. The printed circuit board 260 may be oriented on a plane perpendicular or about perpendicular to the plane of the solar cell module 270, and/or the solar cell mounting portion 297. Antenna platform 235 may be mounted on a top part of printed circuit board 260, for example. As shown in FIGS. 2 and 5, the printed circuit board 160 may be positioned between and/or connecting to the solar cell support structure 290, base portion 240, and/or an interior of side of upper portion 215. Therefore, an internal frame of the printed circuit board 260, solar cell support structure 290, and base portion 240 may be composed which provides rigidity to hold components, such as antenna platform 235 and geo-spatial positioning antenna 225 for more than 3 years of operation, for example.

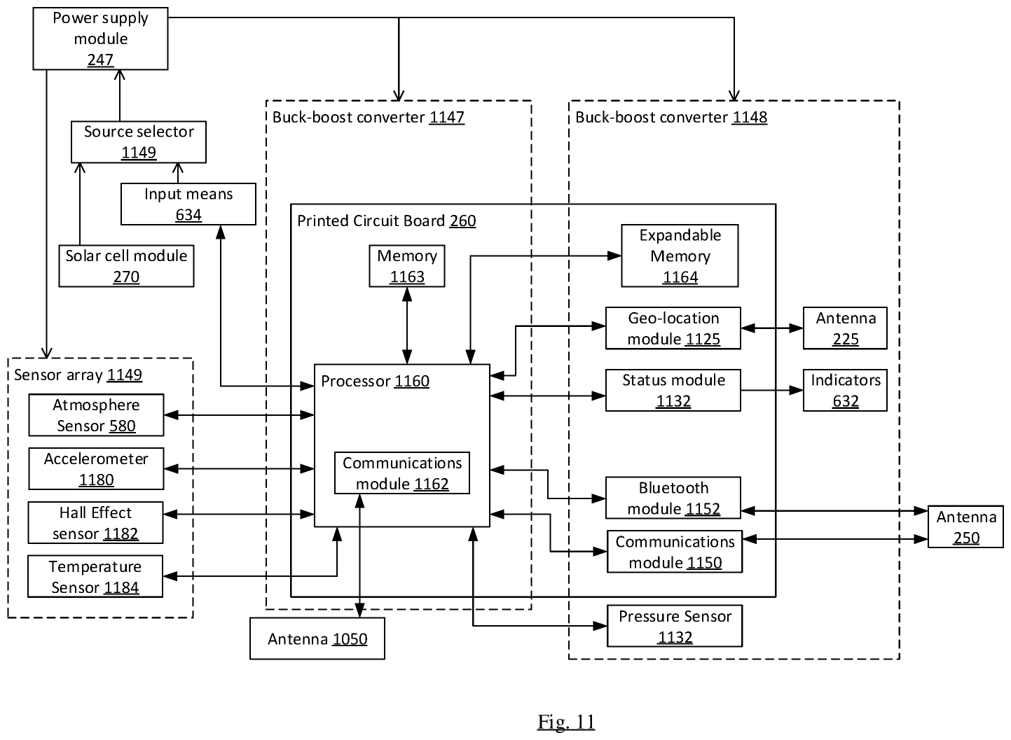

As shown in FIG. 11, device 110 may comprise a number of components on printed circuit board 260 and/or components which send data, receive data, power and/or receive power to/from components on printed circuit board 260. Device 110 may also include a processor 1160, a memory 1163, an expandable memory 1164, a geo-location module 1125, a status module 1132, a bluetooth module 1152, a first communications module 1150, a second communications module 1162, a pressure sensor 1132, an atmosphere sensor 580, an accelerometer 1180, a hall effect sensor 1182, a temperature sensor 1184, an input means 634, a source selector 1149, buck-boost converters 1147 and 1148, indicators 632, and/or a second communications antenna 1050. The atmosphere sensor 580, the accelerometer 1180, the hall effect sensor 1182, and/or the temperature sensor 1184 may be comprised within a sensor array 1149. Device 110 may also comprise other components mountable or printable to printed circuit board 260, such as port expanders, wired connections, and/or circuit components, for example.

In some embodiments, the power supply module 247 may power the sensor array 1149. Therefore, power supply module 247 may power the atmosphere sensor 580, the accelerometer 1180, the hall effect sensor 1182, and/or the temperature sensor 1184. In some embodiments, the power supply module 247 via the buck-boost converter 1147 may supply power to the processor 1160 and/or the memory 1163. In some embodiments, the power supply module 247 via the buck-boost converter 1148 may supply power to the expandable memory 1164, geo-location module 1125, status module 1132, bluetooth module 1152, first communications module 1150, second communications module 1162, and/or pressure sensor 1132, for example. In some other embodiments, no buck-boost converters may be used, rather power supply module 247 directly powers the aforementioned components described in FIG. 11. In some other embodiments, a different allocation of components are powered directly by power supply module 247, buck-boost converter 1147, and/or buck boost converter 1148. In some other embodiments, an allocation of components are powered by a further one or more buck boost converters (not shown).

The processor 1160, the memory 1163, the expandable memory 1164, the geo-location module 1125, the status module 1132, the bluetooth module 1152, the first communications module 1150, the second communications module 1162, the pressure sensor 1132, the atmosphere sensor 580, the accelerometer 1180, the hall effect sensor 1182, the temperature sensor 1184, the source selector 1149, and the buck-boost converters 1147 and 1148 may be contained within the sealed housing 210.

The input means 634, the indicators 632, and/or the second communications antenna 1050 may mount to the exterior of sealed housing 210, and/or be partly contained within sealed housing 210 to assist sealing the sealed housing 210.

In some embodiments, the processor 1160, the memory 1163, the expandable memory 1164, the geo-location module 1125, the status module 1132, the bluetooth module 1152, the first communications module 1150 and/or the second communications module 1162 may be mounted on printed circuit board 260. In some embodiments, the second communications module 1162 may be embedded in processor 1160, for example.

The first communications module 1150, and the second communications module 1162 may be configured for wireless communications. The first communications module 1150, and the second communications module 1162 may be configured for low-power wireless communications. The first communications module 1150 and the second communications module 1162 may be configured for wireless communications over communication link 117 to gateway device 120, as shown in FIG. 1. In some embodiments, the first communications module 1150, and the second communications module 1162 may be configured for different wireless communication standards, such as LTE-M, LoRa™, NB-IoT, Sigfox™, or any other wireless communication standard suitable for LPWAN communication. For example, in some embodiments the first communications module 1150 may be configured for LoRaWAN communications, while the second communications module 1162 may be configured for LTE Cat M1 communications. First communications module 1150 may be configured for a first low power wireless communications standard. In some embodiments, first communications module 1150 is configured for Wi-Fi HaLow™ communications. Second communications module 1162 may be configured for a second low power wireless communications standard. First communications module 1150 may be referred to as LoRa module 1150. First communications module 1150 may be configured for LoRa™ communications. Second communications module 1162 may be referred to as LTE module 1162. Second communications module 1162 may be configured for LTE communications, such as LTE Cat M1 communications. In some embodiments, the first communications module 1150, and the second communications module 1162 may be configured for different communications functions. For example, the first communications module 1150 may be configured to communicate peer to peer with other devices 110 of sensor array 115, wherein one device 110 with a SIM communicates with that gateway 120. Meanwhile, the second communications module 1162 may be configured to provide extended service network coverage on sub 1 GHz bands to allow data transfer from device 110 to cloud services from server system 140, such as processing device 110's data for remote monitoring.

According to some embodiments, the first communications module 1150 and/or bluetooth module 1152 may be communicatively coupled to the first communications antenna 250, as shown in FIG. 11. The second communications module 1162 may be communicatively coupled to the second communications antenna 1050, as shown in FIG. 11. The first communications module 1150, and the second communications module 1162 may be communicatively coupled to processor 1160.

In particular embodiments, processor 1160 includes hardware for executing instructions, such as those making up a computer program. As an example and not by way of limitation, to execute instructions, processor 1160 may retrieve (or fetch) the instructions from an internal register, an internal cache, an internal flash memory, an internal RAM memory, memory 1163, or expandable memory 1164; decode and execute them; and then write one or more results to an internal register, an internal cache, an internal flash memory, an internal RAM memory, memory 1163, or expandable memory 1164. In particular embodiments, processor 1160 may include one or more internal caches for data, instructions, or addresses. This disclosure contemplates processor 1160 including any suitable number of any suitable internal caches, where appropriate. As an example and not by way of limitation, processor 1160 may include one or more instruction caches, one or more data caches, and one or more translation lookaside buffers (TLBs). Instructions in the instruction caches may be copies of instructions in memory 1163 or expandable memory 1164, and the instruction caches may speed up retrieval of those instructions by processor 1160. Data in the data caches may be copies of data in memory 1163 or expandable memory 1164 for instructions executing at processor 1160 to operate on; the results of previous instructions executed at processor 1160 for access by subsequent instructions executing at processor 1160 or for writing to memory 1163 or expandable memory 1164; or other suitable data. The data caches may speed up read or write operations by processor 1160. The TLBs may speed up virtual-address translation for processor 1160. In particular embodiments, processor 1160 may include one or more internal registers for data, instructions, or addresses. This disclosure contemplates processor 1160 including any suitable number of any suitable internal registers, where appropriate. Where appropriate, processor 1160 may include one or more arithmetic logic units (ALUs); be a multi-core processor; or include one or more processors 1160. Processor 1160 may comprise system in package or system on chip. Processor 1160 may comprise Nordic Semiconductor RF9160. Although this disclosure describes and illustrates a particular processor, this disclosure contemplates any suitable processor.

In particular embodiments, memory 1163 includes main memory for storing instructions for processor 1160 to execute or data for processor 1160 to operate on. As an example and not by way of limitation, computer system 1000 may load instructions from expandable memory 1164 or another source (such as, for example, another device/system communicatively coupled to device 110) to memory 1163. Processor 1160 may then load the instructions from memory 1163 to an internal register or internal cache. To execute the instructions, processor 1160 may retrieve the instructions from the internal register or internal cache and decode them. During or after execution of the instructions, processor 1160 may write one or more results (which may be intermediate or final results) to the internal register or internal cache. Processor 1160 may then write one or more of those results to memory 1163. In particular embodiments, processor 1160 executes only instructions in one or more internal registers or internal caches or in memory 1163 (as opposed to expandable memory 1164 or elsewhere) and operates only on data in one or more internal registers or internal caches or in memory 1163 (as opposed to expandable memory 1164 or elsewhere). One or more memory buses (which may each include an address bus and a data bus) may couple processor 1160 to memory 1163. In particular embodiments, one or more memory management units (MMUs) reside between processor 1160 and memory 1163 and facilitate accesses to memory 1163 requested by processor 1160. In particular embodiments, memory 1163 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1163 may include one or more memories 1163, where appropriate. Memory 1163 may comprise Cypress Semiconductor CY15B256Q-SXAT. Although this disclosure describes and illustrates particular memory, this disclosure contemplates any suitable memory.

In particular embodiments, expandable memory 1164 includes mass storage for data or instructions. As an example and not by way of limitation, expandable memory 1164 may include a hard disk drive (HDD), a floppy disk drive, flash memory, an optical disc, a magneto-optical disc, magnetic tape, or a Universal Serial Bus (USB) drive or a combination of two or more of these. Expandable memory 1164 may include removable or non-removable (or fixed) media, where appropriate. Expandable memory 1164 may be internal or external to computer system 1000, where appropriate. In particular embodiments, expandable memory 1164 is non-volatile, solid-state memory. In particular embodiments, expandable memory 1164 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass expandable memory 1164 taking any suitable physical form. Expandable memory 1164 may include one or more storage control units facilitating communication between processor 1160 and expandable memory 1164, where appropriate. Where appropriate, expandable memory 1162 may include one or more storages 1006. Expandable memory 1164 may comprise an SD card. The expandable memory 1164 may comprise storage for backup capabilities. Expandable memory 1164 may comprise enough storage for up to about 240 hours of data from the geo-location module 1125. Although this disclosure describes and illustrates particular storage, this disclosure contemplates any suitable storage.

The distance sensor receiving portion 242, shown at least in FIGS. 2, 4, and 6, may be a sheathing recess 242 for the distance sensor 280 to be housed. In some embodiments, the base of the distance sensor 280 may be exposed when sheathed within the distance sensor receiving portion 242, so as to not acoustically obstruct the distance sensor 280 and to partly visually conceal the distance sensor 280 to reduce the chance of tampering. The distance sensor covering may allow visual concealment of the sensor to reduce the chance of tampering of the device 110 and the distance sensor 280. The distance sensor 280 may at least be part of forming a seal to the sealed housing 210. Distance sensor 280 may be or comprise an ultrasonic sensor. Distance sensor 280 may be configured to measure a distance between a surface and/or object to the distance sensor 280. Distance sensor 280 may be configured to measure a distance between the device 110 and a ground or floor surface below the distance sensor 280 when the device 110 is mounted in an operational orientation. When device 110 is in operational orientation and/or mounted upon equipment and/or structure, the distance sensor 280 may be configured to measure a distance from the distance sensor 280 to a ground surface. Distance sensor 280 may be configured to capture data for relatively large movement and changes of settlement for example.

The antenna receiving portion 248 may comprise one or more recesses and/or a fittings for securing one or more first communications antenna 250 and/or one or more second communications antenna 1050 to extend from the base portion 240. In some embodiments the fittings of the antenna receiving portion 248 comprise polyurethane with a natural finish. In some embodiments, the fittings for securing one or more first communications antenna 250 may comprise one or more respective TNC connectors. In some embodiments, the fittings for securing one or more second communications antenna 1050 may comprise one or more respective SMA connectors.

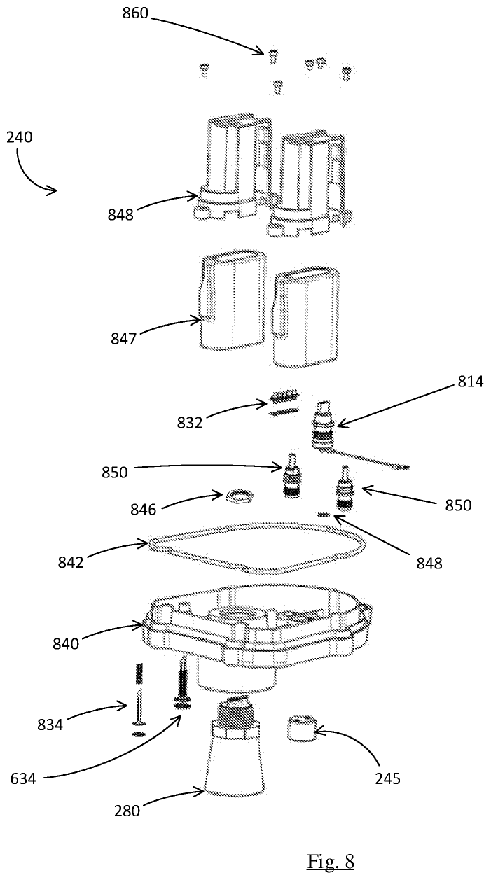

Power supply module 247 may comprise one or more batteries 847, as shown in FIG. 8. Base portion 240 may comprise one or more clamps 848 to secure the one or more batteries 847 to the base portion 240, as shown in FIG. 8. A base assembly may comprise the base portion 240 and the one or more batteries. In some embodiments the one or more batteries 847 comprises two batteries. The one or more batteries 847 may comprise one or more lithium ion batteries. The one or more batteries 847 may comprise one or more long-life lithium ion batteries, such as batteries using lithium iron phosphate, lithium manganese oxide, or lithium nickel manganese cobalt oxide. In some embodiments, the one or more batteries 847 comprises two K2 Energy Ultra High Capacity (3.7 Ah) LiFePO4 K226650UE01 cells.

In some embodiments, the power supply module 247 and/or the one or more batteries 847 may be chargeable by power delivered from the solar cell module 270. In some embodiments, when an external power source is connected to the input means 634, the source selector 1149 will enable the external power source to charge the power supply module 247 and/or the one or more batteries 847. In some embodiments, the source selector 1149 will prevent the solar cell module 270 from charging the power supply module 247 and/or the one or more batteries 847, when the external power source is connected to the input means 634. In some embodiments, the one or more batteries 847 may allow device 110 to operate for up to 3, 4, or 5 years, when assisted by power delivered from the solar cell module 270, without any external power input from power cables or components external to the device 110. In some embodiments, the device 110 may be able to perform up to two weeks GNSS logging without re-charging when the device 110 is located in geo-positions where the latitude is less than about 35 degrees. In some embodiments, the device 110 may be able to perform up to 15 standard GNSS data collection sessions without external power input such as from solar cell module 270. For example, this may be 15 consecutive days of daily readings, or 15 readings bi-weekly across 7 weeks.

In some embodiments, the upper portion 215 and the base portion 240 may comprise one or more types of plastics. The sealed housing 21, upper portion 215 and/or the base portions 240 may comprise “injection moulded” or “vacuum casted” formed plastics. The upper portion 215 and the base portion 240 may comprise polyurethane plastic. The upper portion 215 may comprise a transparent thermoplastic polyamide. The upper portion 215 may comprise EMS Grilamid TR 90 UV. The upper portion 215 may comprise polyurethane Axson PX5210. The base portion 240 may comprise a glass reinforced plastic resin. The base portion 240 may comprise a Polycarbonate Acrylonitrile Styrene Acrylate blend, Polycarbonate Polybutylene Terephthalate, or Acrylonitrile Styrene Acrylate, for example. The base portion 240 may comprise polyurethane Heicast PU8150. In some embodiments, the light transmissive wall 317 may be a different surface finish to the upper portion 215. In some embodiments, when the light transmissive wall 317 is included in the upper portion 215, the light transmissive wall 317 may comprise a different surface finish to the remainder of the upper portion 215. The light transmissive wall 317 may have a smooth and/or polished surface finish. For example, the light transmissive wall 317 may be SPI A-1, SPIA-2, SPI A-3, or VDI 0 surface finish for example. In some embodiments, the remainder of the upper portion 215 and/or sealed housing 210, i.e. the portions of the upper portion 215 and/or sealed housing 210 other than the light transmissive wall 317, may have a coarse, bead blasted, sand blasted, and/or vapour blasted finish. For example, the remainder of the upper portion 215 may be SPI D1, SPI D2, SPI D3, MT-11000, MT-11010, MT11020 and/or MT-11030, VDI 27, VDI 30, VDI 33, and/or VDI 36 for example. In some other embodiments, the remainder of the upper portion 215 and/or sealed housing 210 may have brushed, grit, matte, stone polish, patterned, and/or textured finish so that the remainder of the upper portion 215 and/or sealed housing 210 is opaque or translucent. In some other embodiments, the remainder of the upper portion 215 is still light transmissive or somewhat light transmissive. In some embodiments, the remainder of the upper portion 215 may be painted with paint on the interior and/or exterior surface. In some other embodiments, the light transmissive wall 317 may comprise a different plastic to the upper portion 215. For example, in some other embodiments the light transmissive wall 317 may comprise a transparent thermoplastic polyamide, while the upper portion 215 or remaining upper portion 215 may comprise a glass reinforced plastic resin. Portions of the sealed housing 210 other than the at least one light transmissive wall 317 may be opaque or translucent.

In some embodiments, the peaked top portion 212 may have a narrowing chamber which receives or partly receives the geo-spatial positioning antenna 225. The geo-spatial positioning antenna 225 may be mounted upon the antenna platform 235. When the geo-spatial positioning antenna 225 is located close or in contact with the peaked top portion 212, and when the device 110 is in operational orientation, the geo-spatial positioning antenna 225 may have negligible interference from other device components of device 110. Geo-spatial positioning antenna 225 may be communicatively coupled to the geo-location module 1125. Geo-location module 1125 may be referred to as the geo-spatial positioning module 1125. The geo-location module 1125 may collect position data. Geo-location module 1125 may collect position data from communication via geo-spatial positioning antenna 225 with one or more satellites. Geo-location module 1125 may be configured to generate geo-spatial positioning data based on an output of the geo-spatial positioning antenna 225. The geo-spatial positioning data may specify a geo-spatial position of the position monitoring device 110. Geo-location module 1125 may collect GNSS data, such as GPS, GLONASS, Galileo and/or BeiDou system positioning data, for example. The GNSS data is the GNSS data stream, readings, loggings, and/or measurements described with reference to FIG. 1. Memory 1163 may contain instructions that when executed by processor 1160, cause the processor 1160 to transmit geo-spatial positioning information from the first communications module 1150 to a device external to device 110, such as gateway device 120 or another device 110, for example. The geo-spatial positioning information may be the generated geo-spatial positioning data and/or GNSS data.

In some embodiments, the mounting connector 245 may be located on the base portion 240, and the geo-spatial positioning antenna 225 may be mounted upright on antenna platform 235, wherein the mounting connector 245 and the geo-spatial positioning antenna 225 are in alignment on a vertical axis when the device 110 is in an operational orientation. Therefore, the vertical axis passes through the geo-spatial positioning antenna. Therefore, the vertical axis passes through the mounting connector 245. This may allow the geo-spatial positioning antenna 225 to maintain a phase centre when the device 110 is mounted. For example, when the device 110 is mounted upon a survey pole, the geo-spatial positioning antenna 225 phase centre in communications will be invariant to any twisting action of the device 110 when mounted. Mounting connector 245 may comprise metal composition. Mounting connector 245 may comprise an alloy, such as 6061 T6—Aluminium. Mounting connector 245 may comprise a 5/8″ thread 12 mm deep.

As shown in FIG. 4, in some embodiments, the distance sensor receiving chamber 242 may protrude from the bottom of the base portion 240. The distance sensor receiving chamber 242 may protrude from the base portion 240 by about 15 to 50 millimetres. In some embodiments, the distance sensor receiving chamber 242 may protrude from the base portion 240 by about 15 to 30 millimetres, 20 to 45 millimetres, or 25 to 40 millimetres, for example. In some embodiments, the distance sensor receiving chamber 242 may protrude from the base portion 240 by about 15, 16, 17, 18, 19, 20, 21, 22, 23, 24, 25, 26, 27, 28, 29, 30, 31, 32, 33, 34, or 35 millimetres for example. In some embodiments, the distance sensor receiving chamber 242 may protrude from the base portion 240 by about 27.4 millimetres.

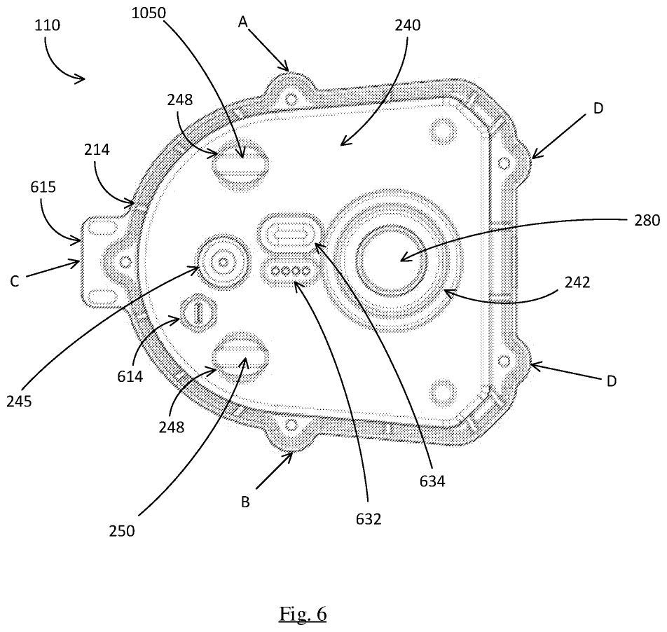

In some embodiments, as shown in FIG. 4 and FIG. 6 (see points A and B in FIG. 6), the base receiving portion 214 may have a width. The base receiving portion 214 may have a width of about 100 to 200 millimetres. The base receiving portion 214 may have a width of about 110 to 155 millimetres, 135 to 175millimetres, or 140 to 180 millimetres, for example. The base receiving portion 214 may have a width of about 140, 141, 142, 143, 144, 145, 146, 147, 148, 149, 150, 151, 152, 153, 154, 155, 156, 157, 158, 159, or 160 millimetres, for example. In some embodiments, the base receiving portion 214 may have a width of about 150.4 millimetres.

In some embodiments, as shown in FIG. 4, the device 110 may have a height between the highest point of the peaked top portion 212 and the bottom of the base receiving portion 214, which may herein be referred to as the upper portion height. In some embodiments the upper portion height may be about 175 to 300 millimetres, for example. The upper portion height may be about 200 to 230 millimetres, 215 to 240 millimetres, or 220 to 270 millimetres, for example. The upper portion height may be about 215, 216, 217, 218, 219, 220, 221, 222, 223, 224, 225, 226, 227, 228, 229, 230, 231, 232, 233, 234, or 235 millimetres, for example. In some embodiments, the upper portion height may be about 226.6 millimetres.

In some embodiments, as shown in FIG. 4, the device 110 may have a height between the highest point of the peaked top portion 212 and the lowest point of the first communications antenna 250 which may herein be referred to as the device height. In some embodiments the device height may be about 250 to 450 millimetres, for example. The device height may be about 300 to 380 millimetres, 350 to 400 millimetres, or 360 to 420 millimetres, for example. The upper portion height may be about 355, 356, 357, 358, 359, 360, 361, 362, 363, 364, 365, 366, 367, 368, 369, 370, 371, 372, 373, 374, 375, 376, 377, or 378 millimetres, for example. In some embodiments, the upper portion height may be about 368.4 millimetres.

In some embodiments, as shown in FIG. 6, the device 110 may have a length along a centred axis of the base from point C, in some embodiments the centred axis passes through the centre of the mounting connector 245 and through the centre of the distance sensor 280, to a point along the centred axis perpendicular to points D, which may herein be referred to as the device length. In some embodiments the device length may be about 140 to 250 millimetres, for example. The device length may be about 145 to 180 millimetres, 165 to 190 millimetres, or 175 to 225 millimetres, for example. The device length may be about 168, 169, 170, 171, 172, 173, 174, 175, 176, 177, 178, 179, 180, 181, 182, 183, 184, 185, 186, 187, or 188 millimetres, for example. In some embodiments, the device length may be about 178.1 millimetres.

According to some embodiments due to the compact dimensions described herein of the device 110, the device 110 may be less prone to movement in high winds and less visible to vandals.

FIG. 6 shows an underside of device 110 according to some embodiments. The underside of device 110 may comprise an exposed face of the base portion 240, surrounded by the base receiving portion 214 of the upper portion 215 of the sealed housing 210. As shown in FIG. 6, the exposed face of base portion 240 may have thereon or extending therefrom status indicators 632, input means 634, physical connectivity port 614, antenna receiving portion 248, distance sensor receiving portion 242, distance sensor 280, first communications antenna 250, second communications antenna 1050, and/or mounting connector 245.

As shown in FIG. 6, the device 110 may comprise a secure portion 615 to lock or fasten the device 110 to a lock and/or object. Secure portion 615 may be a hook for fastening a padlock to device 110. The base receiving portion 214 may include the secure portion 615.

The device 110 may also comprise status indicators 632, as shown in FIG. 6. The base portion 240 may comprise the status indicators 632. In some other embodiments, the status indicators 632 may be mounted behind the light transmissive wall 317 to be visible through the light transmissive wall 317. For example, solar cell mounting portion 297 and/or solar cell support structure 290 may comprise or have mounted thereon status indicators 632, so that the status indicators may be observed from outside the sealed housing 210 through the light transmissive wall 317. The status indicators 632 may comprise one or more light emitting diodes (LEDs). The status indicators 632 may be activated and/or deactivated to indicate a status of components of the device 110. The status indicators 632 may activate/deactivate or emit a particular colour to indicate a status of components of the device 110. The status indicators 632 may indicate status of power supply module 247, solar cell module 270, and/or one or more power measurements for components and/or connections in device 110. The status indicators 632 may indicate the status of signal strength measurements from at least one of the second communications module 1162, the geo-location module 1125, the bluetooth module 1152, the first communications module 1150, the geo-spatial positioning antenna 225, the first communications antenna 250, and/or the second communications antenna 1050. The status indicators 632 may indicate the operational status of components within device 110 such as the memory 1163, the expandable memory 1164, the distance sensor 280, the accelerometer 1180, the hall effect sensor 1182, the temperature sensor 1184, and/or the atmosphere sensor 580, for example. The aforementioned status indications may be controlled by signals sent from the processor 1160 and/or the status module 1132, for example. As shown in FIG. 8, the status indicators 632 may comprise status indicator components 832. The status indicator components 832 may include one or more light pipes, and one or more light pipe gaskets, for example. The light pipe may comprise a plastic, such as clear polycarbonate, for example. The light pipe plastic may comprise a finish, such as a high gloss finish for example.

In some embodiments, as shown in FIG. 6, the device 110 may comprise input means 634. The base portion 240 may comprise the input means 634. The input means 634 may comprise a push button. As shown in FIG. 8, the input means 634 may be a push button comprising a number of button components 834. Button components 834 may include button rubber boot, compression spring, button gasket, and/or a switch arm, for example. The switch arm may comprise polyoxymethylene, for example. The rubber boot may comprise a plastic such as injection moulded polyurethane, for example. The rubber boot plastic may comprise a particular hardness, such as a hardness of Shore 40A, for example. Operation of input means 634 may cause activation or deactivation of one or more components within device 110, such as processor 1160 for example. Operation of input means 634 may turn off device 110, or wake up device 110 for example. In some embodiments, operation of input means 634 may initiate an installation process. In some embodiments, operation of input means 634 may initiate indications of status indicators 632.

The device 110 may also comprise a physical connectivity port 614, as shown in FIG. 6. The physical connectivity port 614 may be a cabled connection interface, such as a USB type c connector. The physical connectivity port 614 may provide connectivity, data communications, and/or power to and/or from external devices from and/or to components within device 110, such as processor 1160, for example. Physical connectivity port may comprise connectivity port components 814, as shown in FIG. 8. Connectivity port components 814 may comprise an usb-c to usb-c connector which is IP67.

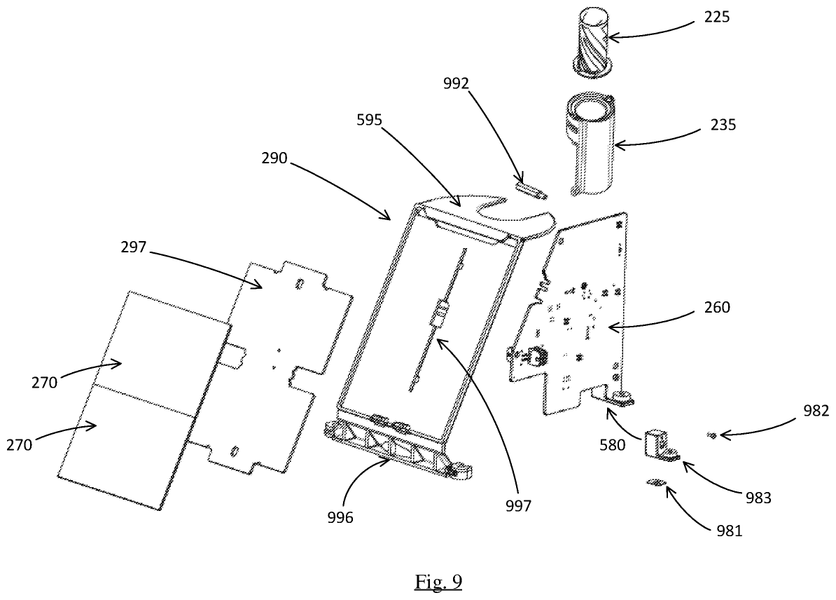

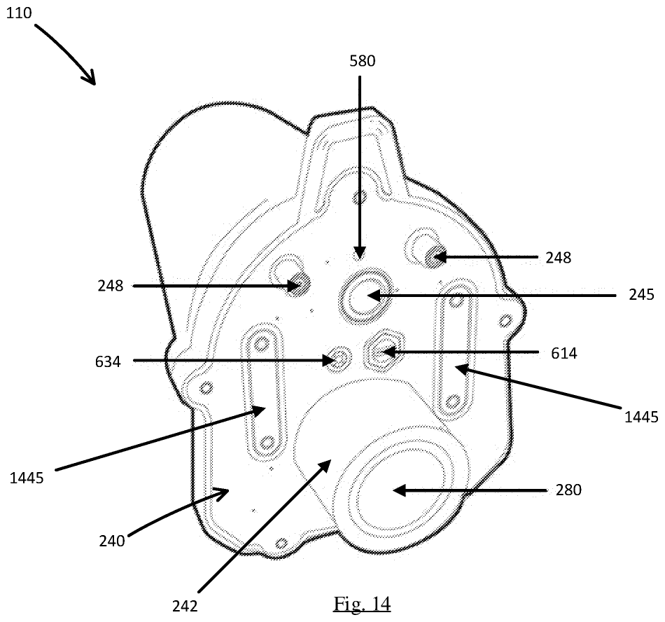

FIG. 5 shows another side perspective of device 110 according to some embodiments. Atmosphere sensor 580 may be located in the lowest heat gain position. Atmosphere sensor 580 may be located in the lowest heat gain position on the PCB 260. For example the atmosphere sensor 580 may be located at the bottom of the PCB 260, in contact with the base portion 240 at the opposite end to the solar module 270, as shown in FIGS. 5 and 9, which may be the lowest heat gain position. The position of atmosphere sensor 580 may be a relatively low heat gain position within the device 110 and/or sealed housing 210. Atmosphere sensor 580 may be communicatively coupled to processor 1160, as shown in FIG. 11. Atmosphere sensor 580 may comprise one or more sensors which measure humidity and/or temperature from within device 110 and send the measured humidity and/or temperature data to processor 1160. Atmosphere sensor 580 may be referred to as atmospheric sensor 580. In some other embodiments, as shown in FIG. 14, Atmosphere sensor 580 may be located on or within a recess of base portion 240. In some embodiments, atmosphere sensor 580 may be located generally between antenna receiving portions 248.

Temperature sensor 1184 may comprise one or more temperature sensors. Temperature sensor 1184 may be communicatively coupled to processor 1160, as shown in FIG. 11. At least one of the one or more temperature sensors may be collocated with the atmosphere sensor 580. In some embodiments, one or more temperature sensors 1184 may be located in other positions within device 110 and sealed housing 210. Temperature sensor 1184 may measure temperature from within device 110 and send the measured temperature data to processor 1160. Device 110 and/or processor 1160 may store the temperature data in memory 1163 and/or expandable memory 1164, accordingly turn off components if the measured temperature data is above a threshold, send one or more of the measured temperature data to gateway 120 and/or server system 140, and/or activate status indicators 632, for example.

Hall effect sensor 1182 and accelerometer 1180 may also be communicatively coupled to processor 1160, as shown in FIG. 11. Hall effect sensor 1182 and/or accelerometer 1180 may be configured to send a signal to processor 1160 wake up processor 1160 upon a vibration event. The signal from hall effect sensor 1182 and/or accelerometer 1180 upon a vibration event, may be sent when the vibration is of a threshold magnitude. Accelerometer 1180 may also be configured to collect acceleration data to enable processor 1160 and/or server system 140 to monitor the device 110's long term stability, for example when the device 110 is mounted upon equipment and/or a structure. Accelerometer 1180 may be an inertial measurement unit.

Pressure sensor 1132 may also be communicatively coupled to processor 1160, as shown in FIG. 11. Pressure sensor 1132 may measure pressure data within sealed housing 210 and send to processor 1160.

In some embodiments, processor 1160 may send status updates to server system 140. The status updates may include a data payload, the data payload comprising data of the current application or firmware installed on processor 1160, the measured temperature data, the measured humidity data, the measured pressure data, the measured acceleration data, the measured height data, measured battery levels and/or voltages from the one or more batteries 847, and/or a charge status of the one or more batteries 847. Processor 1160 may also send communication measurements, such as received signal strength indicators (RSSI), signal to noise ratios (SNR), bit error rates (BER), reference signal received quality (RSRQ), and/or reference signal received power (RSRP) from LTE module 1162 and/or LoRa module 1150. In some embodiments, the status updates may be sent at a continuous interval. The status updates may be sent at a regularity to allow for real-time monitoring.

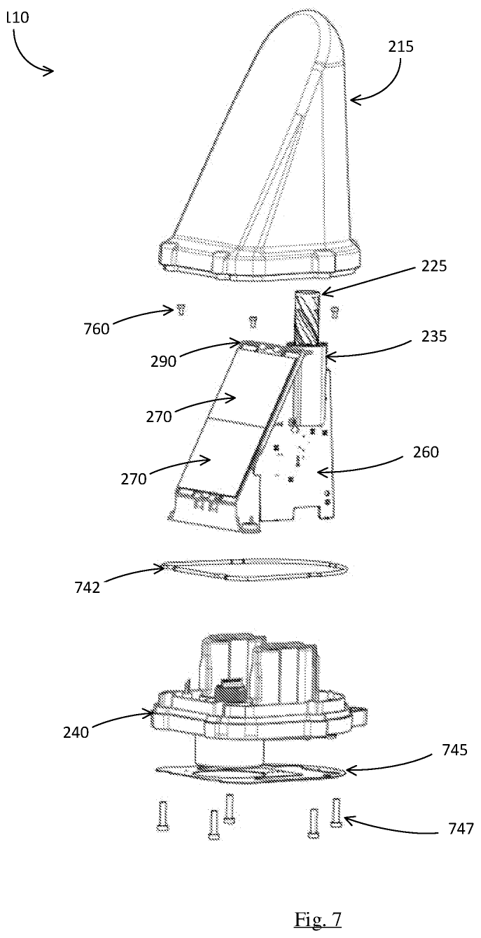

FIG. 7 shows an exploded perspective of components of device 110 according to some embodiments. The components of device 110 shown in FIG. 7 include upper portion 215, printed circuit board 260, geo-spatial positioning antenna 225, solar cell module 270, solar cell support structure 290 and base portion 240. Device 110 may also comprises a screws 760 and 746, top o-ring 742, and reflective decal 745. The reflective decal 745 may comprise reflective silver. The reflective decal 745 may comprise a clear mounting film finish, such as ALC Ultra Clear Mounting Film. The reflective decal 745 or another printed indicia may comprise a printed identifier, such as a QR code, to uniquely identify the device 110.

FIG. 8 shows an exploded perspective of components of the base assembly and base portion 240, according to some embodiments. The components of the base assembly as shown in FIG. 8 may comprise the one or more clamps 848, the one or more batteries 847, a bottom o-ring 842, a base piece 840, a gore vent 848, a nut 846, the button components 834, the mounting connector 245, the status indicator components 832, one or more radiofrequency connectors 850, screws 860, and/or the connectivity port components 814. Also shown in FIG. 8 the base assembly may comprise the distance sensor 280.

FIG. 9 shows an exploded perspective of components of the solar cell support structure 290, the printed circuit board 260, and the geo-positioning antenna 225. The components shown in FIG. 9 also may comprise the solar cell module 270, the solar cell mounting portion 297, the solar extension connection 595, the antenna platform 235, the atmosphere sensor 580, and/or a standoff 992. The atmosphere sensor 580 may comprise a self thread 982, a humidity chamber 983, and a chamber gasket 981. The solar cell support structure 290 may comprise a PCB connection point 997 for securing printed circuit board 260. The solar cell support structure 290 may comprise a solar cell mounting support 296.

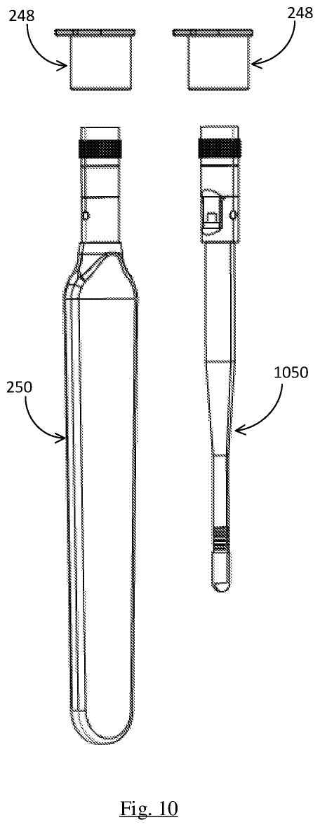

FIG. 10 shows communications antennae of the device 110 according to some embodiments. In some embodiments, the first communications antenna 250 is communicatively coupled to the bluetooth module 1152, the first communications module 1150, and/or the second communications module 1162 for communications with external devices and/or systems, such as gateway 120 and/or server system 140 for example. The first communications antenna 250 may be used in a communication band within about 2.4 to 2.5 GHz, for example. In some embodiments, at least one of the first communications module 1150, and/or the second communications module 1162 may be communicatively coupled to the second communications antenna 1050. The second communications antenna 1050 may be used within a communication band of about 700 to 850 MHz, for example. The communication bands which the first communications antenna 250 and the second communications antenna 1050 are described, are only example candidate bands, it may be fitting that any antenna design for allowing different wireless communication band would be envisaged by the skilled person given network requirements, and communication standards of the first communications module 1150 and the second communications module 1162. Therefore, first communications antenna 250 and second communications antenna 1050 are considered to be designed for other communication bandwidths in other embodiments incorporated to this disclosure, particularly for low power wireless communications.

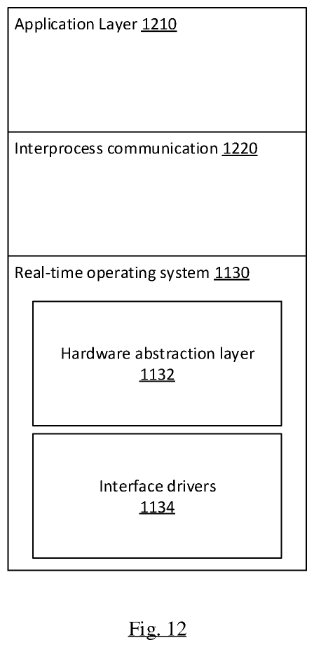

FIG. 12 shows abstraction layers categorising functions and/or code that may be included in processor 1160. Processor 1160 may include an application layer 1210. Applications layer 1210 may include a HTTP handler, a FOTA handler, a Configuration handler, an MQTT handler, a certificate management application, an AWS Just In Time Registration, a command handler, a serial debugger, a Bluetooth handler, a bootloader, a state machine decisions application, a watchdog, a heartbeat servicing application, a status indication application, an impact monitoring application, an atmosphere monitoring application, a temperature monitoring application, a humidity monitoring application, a solar power monitoring application, a battery monitoring application, a GNSS data acquisition monitoring application, a height sense acquisition application, a first communications module handler, and/or a second communications module handler.

Processor 1160 may include or be configured to execute inter-process communication 1220 including message queues, semaphores and/or interrupts, for example.

Processor 1160 may also include or be configured to execute a real-time operating system 1230, such as Zephyr, Mbed, RT-Thread, NuttX or RIOT, for example. Real-time operating system 1230 may include a file system, a thread scheduler, thread management, power management, JSON parser, and/or a compression algorithm, such as LZ4, for example. Real-time operating system 1230 may also include a hardware abstraction layer 1232. Hardware abstraction layer 1232 may include one or more interfaces. The one or more interfaces may comprise a real-time clock (RTC) interface, a watchdog (WDG) interface, a generic status indicators interface, a general-purpose input/output (GPIO) interface, a first and/or second communications module interface, a generic input means interface, a one or more input/output expander interfaces, a geo-positioning interface, a u-blox interface, a generic modem interface, a generic RAM interface, a generic FRAM interface, an external flash interface, and/or an atmosphere sensor interface, for example.

Real-time operating system 1230 may also comprise interface drivers 1234. Interface drivers 1234 may include UART, 12C, GPIO, SPI, and/or Internal Flash drivers, for example. Processor 1160 may be communicatively coupled to components mentioned herein via interfaces and their drivers 1234. Device 110 may also comprise port expanders for the aforementioned interfaces.

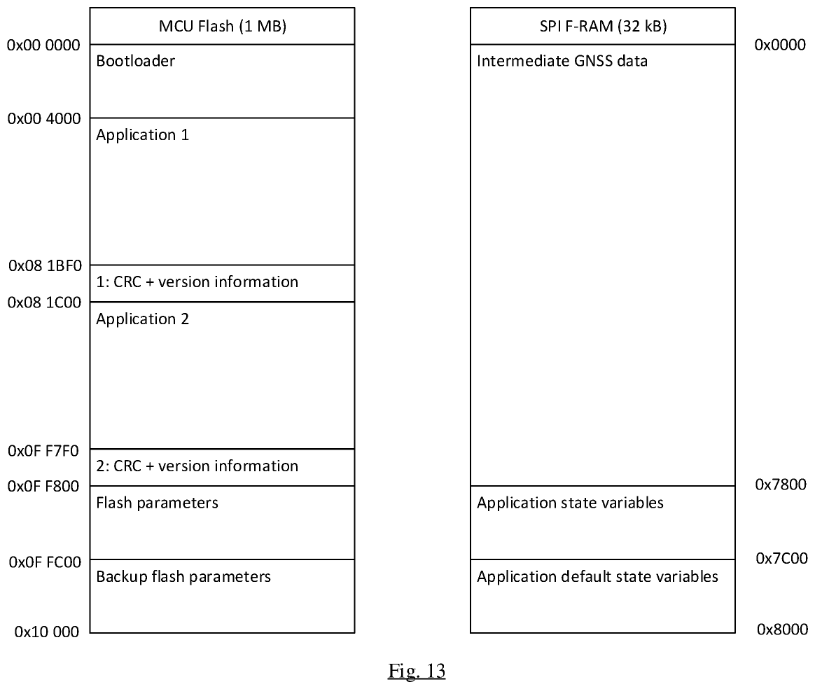

FIG. 13 shows memory allocations according to some embodiments. For example, the processor 1160 may include internal flash memory allocation 1310 for the internal flash memory of processor 1160. Internal flash memory allocation 1310 may be about 256 kB to 4 MB for example. Internal flash memory 1310 may be about 256 kB, 512 kB, 1 MB, 2 MB, 3 MB, or 4 MB, for example. Internal flash memory allocation 1310 may include bootloader, a first application code, cyclic redundancy check and version information for the first application code, a second application code, cyclic redundancy check and version information for the second application code, flash parameters, and/or backup flash parameters, for example.

Device 110 may include a memory allocation 1320 for the memory 1163. Memory allocation 1320 may be about 8 kB to 512 kB for example. Memory allocation 1320 may be about 8 kB, 16 kB, 32 kB, 64 Kb, 128 Kb, 256 kB, or 512 kB, for example. Memory allocation 1320 may include intermediate geo-location data measured and/or processed from geo-location module 1125 and/or processor 1160, application state variables, and/or default application state variables, for example.

In some embodiments, components described for device 110 may be Restriction of Hazardous Substances (RoHS) Directive compliant. In some embodiments, components described herein for device 110 may have an Ingress Protection (IP) rating, or equivalent rating, of IP65 or above, such as IP67, for example. IP65 or above components may be and/or allow device 110 to prevent the ingress of dust and water into the sealed housing 210, and allow the device 110 to be resistant to various weather conditions. In some embodiments, components described for device 110 may have a durability greater than 3 years of use in device 110.

Device 110 may weigh between 1 kilograms and 2 kilograms, for example. In some embodiments, device 110 may weigh about 1.1 to 1.5 kilograms, 1.3 to 1.7, or 1.4 to 2 kilograms. In some embodiments, device 110 may weigh about 1.0, 1.1, 1.2, 1.3, 1.4, 1.5, 1.6, 1.7, 1.8, 1.9, or 2.0 kilograms. In some embodiments, device 110 may be light weight to not impose excessive force on equipment and/or structures. The light weight and materials of device 110 may be selected to increase the likelihood of device 110 withstanding impact from an object or from a fall from a height, such as a height of 2 metres for example.

In some embodiments, the plastics of the sealed housing 210 and/or of device's 110 other components may allow for the internal temperature within sealed housing 210 to remain under 90 degrees Celsius when device 110 is in operation. In some embodiments, the plastics of the sealed housing 210 may be capable of lasting around 5 years in direct sunlight. The plastics and injection molding processes described herein of the sealed housing 210 may be selected to have relatively low costs.

In some embodiments, only a particular segment of the light transmissive wall 317 may be light transmissive, while other segments may be opaque. For example, in some embodiments a segment of the light transmissive wall 317 which is not directly perpendicular or close to the solar cell module 270 may be opaque, such as a segment of the light transmissive wall 317 which is near or part of the top portion 212. This may shade the geo-spatial positioning antenna 225 from light, whilst retaining the transmissibility of light to the solar cell module 270 in other areas.

In some embodiments, the solar cell module 270, solar cell mounting portion 297, and/or solar cell support structure 290 may be oriented, placed, be composed of particular material, and/or have a relative size so as to obstruct light permeating through the light transmissive wall 317 to other components within the sealed housing 210.

In some embodiments the radio devices, such as the processor 1160, the second communications module 1162, bluetooth module 1152, and/or the first communications module 1150 may be placed on low printed circuit board 260 when in operational orientation to maximise shading and minimise heat exposure from the light transmissive wall 317, solar cell mounting portion 297, solar cell support structure 290, and solar module 270, for example.

In some embodiments, the radio devices, such as processor 1160, LTE module 1162, bluetooth module 1152, and/or LoRa module 1150 may be placed at a far distance on printed circuit board 260 from electric noise sources and/or heat permeating from the light transmissive wall 317 and/or upper portion 215.

In some embodiments, the solar cell module 270 and geo-spatial positioning antenna 225 being comprised within the sealed housing 210 may circumvent the need for connective cabling for power or signaling outside of the sealed housing 210. Therefore, the likelihood of failure or inaccuracies in position measurements of the geo-location module 1125 will be minimised with the reduction in the risk of connective cabling becoming loose or degraded by sunlight, the weather, and/or tampering.

In some embodiments, server system 140 is configured to communicate configuration data to at least one of the one or more devices 110. The at least one of the one or more devices 110 can use the configuration data to configure at least one of its processor, memory accessible to the processor 1160, the geo-spatial positioning module 1125, and the first communications module 1150. The communication of configuration data may be in the form of a firmware over-the-air update, for example.

FIG. 14 shows a perspective view of the underside of device 110 according to some other embodiments. In some other embodiments, as shown in FIG. 14, atmosphere sensor 580 may be located on or within a recess of the underside of base portion 240. In some embodiments, atmosphere sensor 580 may be located between antenna receiving portions 248.

According to some other embodiments, as shown in FIG. 14, the exposed face of base portion 240 may have thereon or extending therefrom input means 634, physical connectivity port 614, both antenna receiving portions 248, distance sensor receiving portion 242, distance sensor 280, and/or mounting connector 245. According to some other embodiments, as shown in FIG. 14, the exposed face portion 240 may not include status indicators 632.

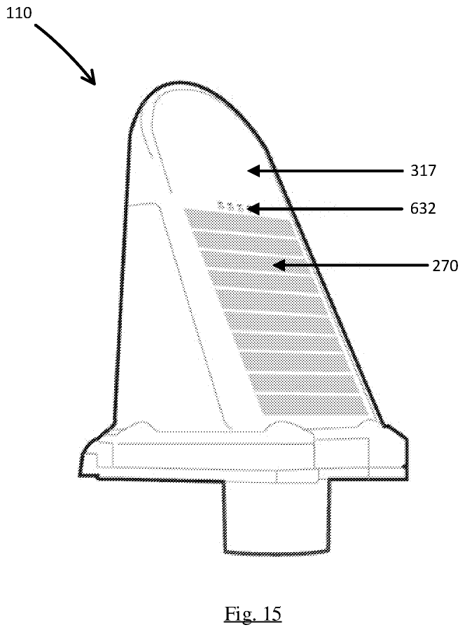

FIG. 15 shows a perspective view of device 110 according to some other embodiments. In such embodiments, the status indicators 632 may be mounted behind the light transmissive wall 317 to be visible through the light transmissive wall 317. For example, solar cell mounting portion 297 and/or solar cell support structure 290 may comprise or have mounted thereon status indicators 632, so that the status indicators may be observed from outside the sealed housing 210 through the light transmissive wall 317.

As shown in FIG. 15, solar cell module 270 may comprise around 10 solar cell arrays and/or solar modules on a single panel.

1. A position monitoring device, comprising:
a processor;
memory accessible to the processor;
a geo-spatial positioning antenna;
a geo-spatial positioning module coupled to the geo-spatial positioning antenna and configured to generate geo-spatial positioning data based on an output of the geo-spatial positioning antenna that specifies a geo-spatial position of the position monitoring device;
a power supply module;
a solar cell module to charge the power supply module;
a first communications module; and
a sealed housing containing the processor, the geo-spatial positioning module, the geo-spatial positioning antenna, the solar cell module, the power supply module, and the first communications module;
wherein the memory contains instructions which, when executed by the processor, cause the processor to:
transmit geo-spatial positioning information from the first communications module to a device external to the position monitoring device.

2. The position monitoring device of claim 1, wherein the sealed housing includes at least one light transmissive wall to allow light into the sealed housing in an area within the sealed housing where the solar cell module is mounted.

3. The position monitoring device of claim 2, wherein the solar cell module is located near the at least one light transmissive wall so that there is a direct path for light to enter through the sealed housing to the solar cell module.

4. The position monitoring device of claim 3, wherein portions of the sealed housing other than the at least one light transmissive wall are opaque or translucent.

5. The position monitoring device of claim 2, wherein the position monitoring device includes an operational orientation having an upright posture, wherein the sealed housing comprises a peaked top portion, the peaked top portion being the uppermost portion of the sealed housing when the position monitoring device is in the operational orientation.

6. The position monitoring device of claim 5, wherein the peaked top portion defines a narrowing chamber that receives the geo-spatial positioning antenna.

7. The position monitoring device of claim 5, wherein the sealed housing comprises a base portion, the base portion being a lowermost portion of the sealed housing when the position monitoring device is in the operational orientation.

8. The position monitoring device of claim 7, wherein the at least one light transmissive wall extends between the base portion and peaked top portion, the at least one light transmissive wall angled from its highest point between about 90 and 175 degrees from a vertical axis when in the operational orientation.

9. The position monitoring device of claim 7, wherein the sealed housing comprises an upper portion, and the upper portion and base portion are formed by injection-molded plastics.

10. The position monitoring device of claim 9, wherein the upper portion includes the peaked top portion and the at least one light transmissive wall.

11. (canceled)

12. The position monitoring device of claim 7, wherein the base portion comprises a mounting connector to allow the position monitoring device to be mounted upon equipment and/or a structure.

13. The position monitoring device of claim 12, wherein the position monitoring device comprises an antenna platform, the geo-spatial positioning antenna is mounted upright on the antenna platform, the geo-spatial positioning antenna aligned on a vertical axis when the device is in the operational orientation, the vertical axis also passing through the mounting connector.

14. The position monitoring device of claim 7, wherein the power supply module is housed on a base assembly, the base assembly including the base portion.

15. The position monitoring device of claim 3, wherein the solar cell module is mounted on a solar mounting portion, the solar mounting portion located near the at least one light transmissive wall so that there is a direct path for light to enter through the sealed housing to the solar cell module.

16. The position monitoring device of claim 15, wherein the solar cell module and solar mounting portion are oriented parallel to the at least one light transmissive wall, so that they are also angled from their highest point between about 90 and 175 degrees from a vertical axis when the device is in the operational orientation.

17. The position monitoring device of claim 15, wherein the solar cell module and/or solar mounting portion are oriented and are of relative size so as to obstruct light permeating through the at least one light transmissive wall to other components within the sealed housing.

18. (canceled)

19. The position monitoring device of claim 1, further comprising a printed circuit board, PCB, located in the sealed housing, wherein the PCB is mounted vertically when the device is in the operational orientation.

20. (canceled)

21. The position monitoring device of claim 19, wherein the PCB has an antenna platform mounted to a top part of the PCB.

22. The position monitoring device of claim 7, wherein the first communications module is configured for a first low power wireless communications standard and the position monitoring device further comprises a first communications antenna communicatively coupled to the first communications module, wherein the first communications antenna is fitted to extend from the base portion.

23. (canceled)

24. The position monitoring device of claim 7, further comprising a distance sensor, to measure a distance between the device and a ground or floor surface below the distance sensor when the device is mounted.

25. The position monitoring device of claim 24, wherein the base portion comprises a sheathing recess so that the distance sensor may be housed within the sheathing recess.

26. (canceled)

27. The position monitoring device of claim 1, further comprising an inertial measurement unit, IMU, wherein upon a vibration of a threshold magnitude, the IMU is configured to send a signal to the processor to activate the processor.

28. (canceled)

29. The position monitoring device of claim 19, further comprising one or more atmospheric sensors, wherein the one or more atmospheric sensors are contained within the lowest heat gain position on the printed circuit board.

30. The position monitoring device of claim 22, further comprising a second communications module configured for a second low power wireless communications standard, and the position monitoring device further comprises a second communications antenna communicatively coupled to the second communications module, the second communications antenna fitted to extend from the base portion.

31. A system for monitoring settlement comprising one or more position monitoring devices of claim 1, a gateway for forwarding collected data from the one or more position monitoring devices, and a server system for processing the forwarded data.

32. The system of claim 31, wherein the server system is configured to communicate configuration data to at least one of the one or more position monitoring devices, the at least one of the one or more position monitoring devices being able to use the configuration data to configure at least one of its processor, memory accessible to the processor, the geo-spatial positioning module, and the first communications module.
